(19) United States
(12) Patent Application Publication
(10) Pub. No.: US 2026/0150974 A1
(43) Pub. Date: Jun. 4, 2026

(54) CUTTING AND COUPLING METHOD AND SYSTEM

(71) Applicant: Roberto TROVI, Quarrata (PT) (IT)

(72) Inventor: Roberto TROVI, Quarrata (PT) (IT)

(21) Appl. No.: 19/405,370

(22) Filed: Dec. 1, 2025

(30) Foreign Application Priority Data
Dec. 2, 2024 (IT) 102024000027195

(51) Int. Cl. A47C 27/07

(52) U.S. Cl. CPC A47C 27/07

(57) ABSTRACT

Cutting and coupling method, including the steps of providing a first sheet of resilient material and moving it towards a first coupling area; providing a spring pack and moving it towards said first coupling area; gluing a contact surface of said first sheet to a first lateral surface of said spring pack and cutting a first portion of said first sheet glued to said spring pack, thereby obtaining a first spar.

This application claims priority to Italian Patent Application 102024000027195 filed Dec. 2, 2024, the entirety of which is incorporated by reference herein.

The present invention relates to a cutting and coupling method and system.

In particular, the present invention relates to a method for cutting a plurality of spars and coupling them to a spring pack for the making a semi-finished product intended for the production of spring mattresses.

Spring mattresses are a type of mattress that contain a set of springs, generally held together (the springs) by a fabric cover or connecting elements.

In addition to the spring pack, the spring mattress also includes at least one lower resilient material sheet, one upper resilient material sheet, and a number of side edges, known as spars, which are also made of resilient material.

The present invention also relates to a cutting and coupling system.

Today, spring mattresses are made using purely manual or semi-automatic procedures, which generally consist of the following sequence of steps.

First, the bottom sheet is prepared and the spring pack is placed centrally thereon.

The bottom sheet extends over a larger area than the spring pack so as to leave a peripheral cord on the bottom sheet and allow the subsequent positioning of the aforementioned spar on the cord itself.

The spars are glued to the bottom sheet and are positioned resting only on the spring pack.

At this point, the top sheet is positioned to close the mattress, with the possible addition of further sheets with different resilience characteristics or other features, known as “comfort layers.”

The methods and systems currently used to manufacture spring mattresses have various drawbacks.

In particular, one drawback of the known methods and systems is their inadequate production speed.

In fact, these methods often involve slow and laborious manual actions.

Another drawback of the known methods and systems is that they do not allow for adequate assembly quality. To overcome these problems, there are now methods and systems for pre-assembling a semi-finished product that forms a single body consisting of a spring pack and perimeter spars glued to it.

The manufacturing of a semi-finished product makes it possible to speed up and standardize the subsequent operations for assembling a complete spring mattress.

These semi-finished products are currently manufactured using semi-automatic systems.

The known methods of assembling a semi-finished product are not without drawbacks.

In fact, they are often slow and cumbersome.

Another drawback is that the quality of the finished product is not always optimal.

It is therefore an object of the present invention to provide a cutting and coupling method and system capable of overcoming the drawbacks of the current state of the art.

Another object of the present invention is to provide a cutting and coupling method and system capable of optimizing production times.

Another object of the present invention is to provide a cutting and coupling method and system capable of ensuring optimal production quality.

According to the invention, these and other objects are achieved by a cutting and coupling method and system having the technical characteristics described in the attached claims.

The technical characteristics of the invention, according to the above objects, are clearly described in the attached claims, and its advantages are apparent from the detailed description that follows, with reference to the attached drawings that illustrate purely exemplary and non-limiting embodiments, wherein:

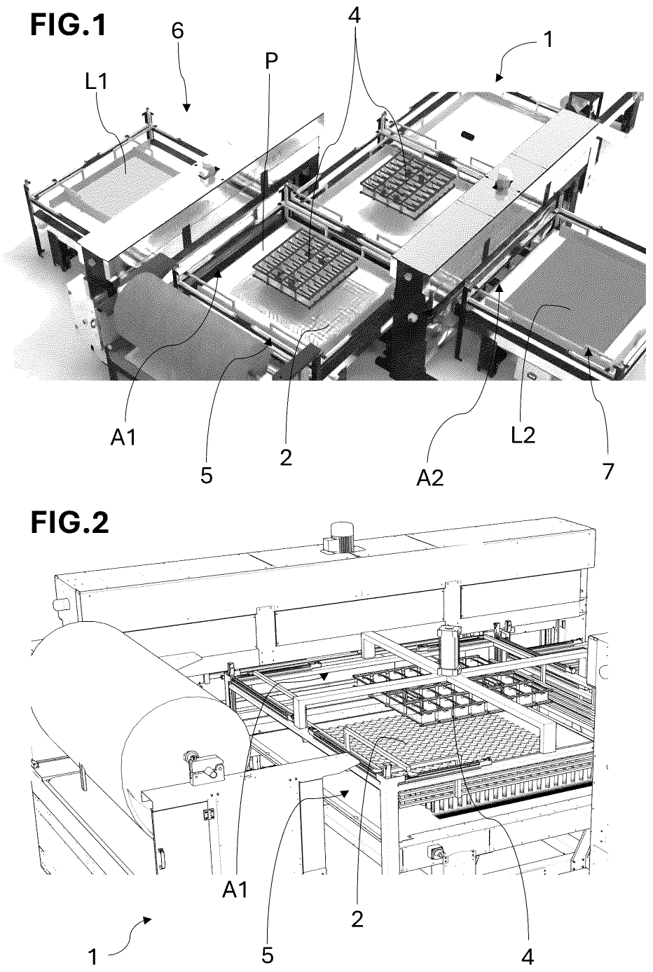

FIG. 1 illustrates a schematic perspective view from above of a cutting and coupling system according to the present invention,

FIG. 2 illustrates a schematic perspective view from above of a detail of the system shown in FIG. 1,

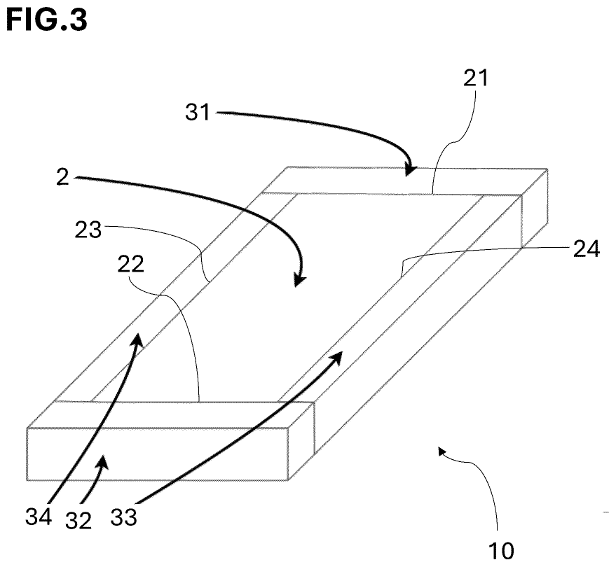

FIG. 3 illustrates a schematic view of a semi-finished product 10 manufactured using the method and system of the present invention.

The subject matter of the present invention is therefore a cutting and coupling method, hereinafter also referred to simply as the “method.”

With reference to FIG. 1 attached, the method covered by the present invention includes a step of arranging a first sheet L1 of resilient material.

By resilient material it is meant a material that has the ability to absorb mechanical energy, deform under the action of a force, and then return to its original shape once the force ceases to act.

By “Sheet” it is meant a body made of resilient material, substantially parallelepiped in shape, geometrically defined by three orthogonal dimensions: length, width, and thickness.

Advantageously, the sheet L1 is designed with a length and thickness already calibrated to correspond exactly to the final dimensions of the spar 31 to be applied to the spring pack 2.

Thanks to this feature, the cutting operation performed at station 5 is limited exclusively to separating the spar along the width of the sheet, i.e., making a longitudinal cut with respect to the sheet. Therefore, no cross-cutting operation is required to adjust the length, nor are any thickness adjustment operations required, since the newly separated spar 31 already has the correct geometry for immediate coupling with the corresponding lateral surface 21 of the spring pack.

The method includes a phase of moving the first sheet L1 towards a first coupling area A1.

As will become clear in the following discussion, by coupling means it is meant the joining, for example by gluing, of a spring pack with respective spars to form a semi-finished product.

As explained in the introduction to this description, a semi-finished product refers to a single body, comprising a spring pack and respective spars, designed to provide the basis for the assembly of a spring mattress.

The method includes a step of arranging a spring pack 2.

The method includes a step of moving the spring pack towards the first coupling area A1.

Essentially, the spring pack 2 and the first sheet L1 are moved toward the same area A1.

The method then includes a step of gluing a contact surface of the first sheet L1 to a first lateral surface 21 of the spring pack 2.

The gluing step is advantageously carried out using special spray or spread-type gluing means. These gluing means (not shown) are advantageously arranged in proximity to said first coupling area A1.

The method comprises a step of cutting a first portion of the sheet L1 glued to the spring pack 2.

This cutting step allows a first spar 31 to be obtained, which is glued to the first lateral surface 21 of the spring pack 2.

The cutting step takes place after the step of gluing the sheet L1, in order to promote optimal gluing. Advantageously, the cutting step involves cutting the sheet L1 using a blade that descends perpendicularly onto the L1 sheet itself, at a predetermined distance from the coupling area A1.

This distance corresponds to the thickness of the predetermined spar depending on the type of mattress being produced. Advantageously, the thickness of the cut spar is predetermined according to the specific type of mattress being produced.

These steps allow a spar 31 to be quickly and effectively applied to a lateral surface of the spring pack 2.

Advantageously, the method according to the present invention comprises a step of rotating the spring pack 2 to glue at least one additional spar 32, 33, 34.

According to a non-illustrated embodiment, the step of rotating the spring pack 2 to glue at least one additional spar comprises the steps of:
providing moving and rotation means formed on a bearing plane of the spring pack 2 itself. These moving and rotation means allow the spring pack 2 to be lifted from the bearing plane and rotated by a certain angle to allow one of the lateral surfaces of the spring pack 2 itself to face one of the coupling areas A1 and A 2.

Alternatively, according to the embodiment illustrated, this step of rotating the spring pack 2 to glue at least one additional spar comprises the steps of:
providing a gripping and moving device 4;
lifting the spring pack 2 using a gripping and moving device 4;
rotating the spring pack 2;
releasing the spring pack 2 onto a bearing plane P in proximity to the coupling areas A1 and A2.

According to a first embodiment, the step of rotating the spring pack 2 to glue at least one additional spar 32, 33, 34 includes a step of rotating the spring pack 2 by 180°.

This embodiment of the method provides for the presence of a spring pack having two long sides and two short sides, essentially presenting a rectangular surface.

Therefore, after applying the first spar 31, the spring pack 2 is rotated by 180° so as to expose a second lateral surface 22, defining a second short side, towards the coupling area A1.

This method therefore includes the step of moving the spring pack 2 towards the first coupling area A1.

It then includes the step of gluing a contact surface of the first cut sheet L1 to a second lateral surface 22 of the spring pack 2 and the step of cutting a second portion of the first sheet L1 glued to the spring pack 2, thus obtaining a second spar 32 which is then glued to the spring pack 2. Following these steps, the rectangular spring pack 2 has a first 31 and a second 32 spar formed on the short sides of the spring pack 2.

It is understood that the method, according to this embodiment, may first involve gluing the spars on the long sides and then gluing the spars on the short sides.

According to this embodiment, it is advantageous to rotate the spring pack by 90°. In this way, the rectangular spring pack (meaning the upper and lower surfaces) is positioned so that it can face a subsequent coupling area A2 (introduced below) on one of its long sides.

This embodiment therefore comprises the following steps:
transferring the spring pack 2 towards the coupling area A2;
providing a second sheet L2 of resilient material with a greater width than the first sheet L1;
   this increased width allows for the cutting of spars suitable for application on the long sides of the spring pack 2;
moving the second sheet L2 towards the second coupling area A2;
gluing a contact surface of the second sheet L2 to a third lateral surface 23 of the spring pack 2.
cutting a first portion of the second sheet L2 glued to the spring pack 2, thus obtaining a third spar 33 glued to the spring pack 2 itself.
rotating the spring pack 2 by 180°; this step allows a fourth side surface 24 to be exposed towards the coupling area A2.
moving the spring pack 2 towards the second coupling area A2;
gluing a contact surface of the second sheet L2 cut out with a fourth lateral surface 24 of the spring pack 2;
cutting a second portion of the second sheet L2 glued to the spring pack 2, thus obtaining a fourth spar 34.

These steps optimize the speed of execution and the quality of the coupling of four spars (two long and two short) on four lateral surfaces of the rectangular spring pack.

According to a further embodiment, the method allows the assembly of a semi-finished product (spring pack plus spars) with a square upper and lower surface, i.e., the spring pack 2 has four equal lateral surfaces.

According to this embodiment, the step of rotating the spring pack 2 to glue at least one additional spar 32, 33, 34 comprises the steps of:
rotating the spring pack 2 so that a second surface 22 of the pack 2 itself faces the first coupling area A1;
moving the spring pack 2 towards the first coupling area A1;
gluing a contact surface of the first cut-out sheet L1 to the second surface 22 of the spring pack 2;
cutting a second portion of the first sheet L1 glued to the spring pack 2, thus obtaining a second spar 32.

These steps, according to the square spring pack 2 design, are advantageously repeated for the other lateral surfaces of the pack 2 itself.

The following steps then follow:
rotating the spring pack 2 so that a third surface 23 of the pack 2 itself faces the first coupling area A1;
moving the spring pack 2 towards the first coupling area A1;
gluing a contact surface of the first sheet L1 cut out with the third surface 23 of the spring pack 2;
cutting a third portion of the first sheet L1 glued to the spring pack 2, thus obtaining a third spar 33;
rotating the spring pack 2 so that a fourth surface 24 of the pack 2 itself faces the first coupling area A1;
moving the spring pack 2 to the first coupling area A1;
gluing a contact surface of the first sheet L1 cut out with the fourth surface 24 of the spring pack 2;
cutting a fourth portion of the first sheet L1 glued to the spring pack 2, thus obtaining a fourth spar 34.

This further embodiment allows a semi-finished product with a square surface to be assembled quickly, optimizing quality.

A further object of the present invention is a cutting and coupling system, indicated in the attached figures by reference “1,” and referred to hereinafter simply as system 1. With reference to FIG. 1 attached, the system 1 comprises a first station 5 designed to feed a sheet L1 of resilient material to a first coupling area A1 for at least partial assembly of a semi-finished product 10. The system 1 includes a second station 6 designed to feed a spring pack 2 to the first coupling area A1 for at least partial assembly of the semi-finished product 10.

The system 1 also includes gluing means (not shown) arranged in proximity to the first coupling area A1.

These gluing means are designed to apply an adhesive layer to at least one contact surface between the first sheet L1 and the spring pack 2.

The system 1 includes a cutting device arranged in proximity to the first coupling area A1 and designed to cut a portion of the first sheet L1 of resilient material in order to obtain a first spar 31.

This first spar 31 is glued to the spring pack 2 on its first lateral surface 21.

According to the embodiment illustrated in the attached figures, the system 1 advantageously includes a gripping and rotating device 4 configured to rotate the spring pack 2 at least on its second lateral surface 22.

This allows the spring pack to be exposed towards the first coupling area A1 on its second lateral surface 22, so that a second spar 32 can be glued to this second lateral surface 22.

According to an embodiment in which the spring pack has a rectangular shape, the system 1 of the present invention includes a second coupling area A2 for gluing a third and fourth spar 33 and 34 onto the respective third and fourth lateral surfaces of the spring pack 2. Again with reference to the embodiment illustrated in the attached figures, the coupling area A2 comprises a respective gripping and rotating device 4 configured to rotate the spring pack 2 and a respective cutting device for the second sheet L2 to obtain the aforementioned third and fourth spar 33 and 34.

Advantageously, this cutting device is essentially structured like a guillotine.

Advantageously, the cutting devices for the respective first and second sheets L1 and L2 allow further cutting along the length of the sheet themselves, so as to adjust the length of the spars 31, 32, 33, 34 to be applied to the spring pack 2.This allows the system to be further optimized to obtain semi-finished products 10 of any mattress size, both on the long and short sides.

Advantageously, the sheet L2 has a greater width than the sheet L1, and is particularly suitable for coupling spars of equal length to the long sides of the spring pack 2.

Advantageously, the second sheet L2 is fed by a third feeding station 7.

According to a further embodiment not illustrated, the system 1 of the present invention comprises moving and rotation means provided on a support surface of the spring pack 2. These moving and rotation means allow the spring pack 2 to be moved between the first coupling area A1 and the second coupling area A2 and rotated so as to select any of the lateral surfaces 21, 22, 23, 24 of the spring pack 2 to face any of the coupling areas A1 and A2.

Advantageously, these moving and rotation means, formed on the bearing plane, allow the spring pack 2 to be lifted and rotated.

The method and system according to the present invention allow the drawbacks of the prior art to be overcome and significant advantages to be achieved.

One advantage of the method and system according to the present invention is that it optimizes the production speed of a semi-finished product.

Another advantage of the method and system according to the present invention is that it ensures optimal production quality of semi-finished products for the subsequent manufacture of spring mattresses.

Another advantage of the method and system according to the present invention is that it ensures optimized handling of the spars, substantially eliminating the need to move them before coupling them with the spring pack.

Another advantage of the method and system according to the present invention is that it optimizes the handling of the thicknesses of the spars.

The cutting stations in the system according to the present invention allow the thicknesses to be adjusted to ensure optimal results regardless of the model of semi-finished product to be obtained.

Furthermore, this invention makes it possible to continuously produce even small batches of mattresses of different sizes, as the cutting devices are controlled each time to define the correct thickness of the spars themselves.

1. A cutting and coupling method, comprising the following steps in precise order:
arranging a first sheet of resilient material;
moving said first sheet of resilient material towards a first coupling area;
providing a spring pack;
moving said spring pack towards said first coupling area;
gluing a contact surface of said first sheet to a first lateral surface of said spring pack;
cutting a first portion of said first sheet glued to said spring pack, thus obtaining a first spar glued to said first lateral surface of said spring pack,
said method being characterized by the fact that it includes a step of rotating said spring pack to glue at least one further spar onto said spring pack.

2. The method according to claim 1, wherein said step of rotating said spring pack to glue at least one additional spar comprises the steps of:
rotating said spring pack by 180°;
moving said spring pack towards said first coupling area;
gluing a contact surface of said first sheet cut out with a second lateral surface of said spring pack;
cutting a second portion of said first sheet glued to said spring pack, thus obtaining a second spar.

3. The method according to claim 2, wherein said step of rotating said spring pack to glue at least one additional spar comprises, after said step of cutting a second portion of said first sheet, also the steps of:
rotating said spring pack by 90°;
transferring said spring pack towards a second coupling area;
providing a second sheet of resilient material with a greater width than said first sheet;
moving said second sheet towards said second coupling area;
gluing a contact surface of said second sheet to a third lateral surface of said spring pack;
cutting a first portion of said second sheet glued to said spring pack, thus obtaining a third spar;
rotating said spring pack by 180°;
moving said spring pack towards said second coupling area;
gluing a contact surface of said second sheet cut out with a fourth lateral surface of said spring pack;
cutting a second portion of said second sheet glued to said spring pack, thus obtaining a fourth spar.

4. The method according to claim 1, wherein said step of rotating said spring pack to glue at least one additional spar comprises the steps of:
rotating said spring pack so as to turn a second surface of said spring pack towards said first coupling area;
moving said spring pack towards said first coupling area;
gluing a contact surface of said first sheet cut out with said second lateral surface of said spring pack;
cutting a second portion of said first sheet glued to said spring pack, thus obtaining a second spar;
rotating said spring pack so as to turn a third surface of said spring pack towards said first coupling area;
moving said spring pack towards said first coupling area;
gluing a contact surface of said first sheet cut out with said third lateral surface of said spring pack;
cutting a third portion of said first sheet glued to said spring pack, thus obtaining a third spar;
rotating said spring pack so as to turn a fourth surface of said spring pack towards said first coupling area;
moving said spring pack towards said first coupling area;
gluing a contact surface of said first cut sheet to said fourth lateral surface of said spring pack;
cutting a fourth portion of said first sheet glued to said spring pack, thus obtaining a fourth spar.

5. The method according to claim 1, wherein said step of rotating said spring pack to glue at least one further spar comprises the steps of:
providing a gripping and moving device;
lifting said spring pack by means of said gripping and moving device;
rotating said spring pack;
releasing said spring pack onto a bearing plane in proximity to said coupling area (A1, A2).

6. A cutting and coupling system, comprising:
a first station designed to feed a sheet of resilient material to a first coupling area for at least partial assembly of a semi-finished product;
a second station designed to feed a spring pack towards said first coupling area for at least partial assembly of said semi-finished product;
gluing means arranged near said first coupling area and designed to apply an adhesive layer to at least one contact surface between said first sheet and said spring pack;
a cutting device arranged in proximity to said first coupling area and designed to cut a portion of said first sheet of resilient material so as to obtain a first spar, said first spar being glued to said spring pack on a first lateral surface thereof,
said system being characterized by the fact that it comprises a device for gripping and rotating said spring pack configured to rotate it at least on a second lateral surface of said spring pack, so as to glue a second spar onto said second lateral surface.

7. The system according to claim 6 wherein said spring pack has a rectangular shape, characterized in that it comprises a second coupling area for gluing a third and fourth spar to a third and fourth surface of said spring pack.

8. The system according to claim 7, wherein said second coupling area comprises a respective gripping and rotating device configured to rotate said spring pack and a respective device for cutting said second sheet of resilient material.
